(19) United States
(12) Patent Application Publication
(10) Pub. No.: US 2005/0151707 A1
(43) Pub. Date: Jul. 14, 2005

(54) Apparatus and method for operating flat panel display

(75) Inventor: Seung Kyun Park, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/030,195

(22) Filed: Jan. 7, 2005

(30) Foreign Application Priority Data
Jan. 10, 2004 (KR) 10-2004-0001802

(51) Int. Cl. G09G 3/30

(52) U.S. Cl. 345/76

(57) ABSTRACT

A flat panel display, more particularly, a PAM flat panel display featuring low power-consumption is disclosed. The flat panel display includes a current reference generator for generating a data drive current reference for providing a drive current proportional to the size of an input data from outside, and a charge/discharge current reference according to a difference of the data size between the scan lines; and a data driver output for providing directly to the display panel a current corresponding to each of the current references. The flat panel display can be advantageously used in that it reduces the amount or the discharge current that has no effective contribution towards the emission of light by regulating the charge and discharge current of the data drive according to the size of an input data, consequently reducing the total power consumption.

This application claims the benefit or the Korean Patent Application No. 10-2004-0001802, filed on Jan. 10, 2004, which is hereby incorporated by reference as if fully set forth herein.

### BACKGROUND OF THE INVENTION

1. Field of the Invention

The present invention relates in general to a flat panel display, and more particularly, to an apparatus and method for operating a flat panel display.

2. Background of the Related Art

Technical advances in cathode ray tubes have brought the development of flat panel displays with reduced weight and volume. Examples of the flat panel display include LCDs (Liquid Crystal Displays), FEDs (Field Emission Displays), PDPs (Plasma Display Panels), organic EL (Electro Luminescence) displays.

Particularly, the organic EL display stands along among other LCDs for its many advantages including a thinner screen, faster response speed; superior visibility due to the self-luminescent characteristics, and larger viewing angle. Thus, many studies are now under way in worldwide.

Organic EL displays come in diverse operation systems depending on their size. For instance, a large and medium-sized organic EL display adopts an active operating system, and a small-sized organic EL display adopts both active and passive operating systems.

More specifically, the passive operating system for the small-sized organic EL display utilizes pulse width modulation (hereinafter it is referred to as ‘PWM’) and pulse amplitude modulation (hereinafter it is referred to as ‘PAM’).

To explain how the organic EL display is operated, FIG. 1 illustrates a related art organic EL display panel and operation module thereof.

As shown in FIG. 1, the operation module of the organic EL display panel includes an organic EL display panel 3, a data driver 1 for operating the panel 3, and a scan driver 2.

If an enable signal is issued sequentially to each line through the scan driver 2 the data driver 1 provides a data signal through a data line, and each pixel PE of the organic EL display panel 3 generates light corresponding to the magnitude of the data signal.

In effect, the PWM and the PAM are distinguished by the output waveform of the data signals provided by the data driver 1. More details on these will be provided with reference to drawings.

FIG. 2 illustrates an output waveform of a data driver when the organic EL display panel of FIG. 1 is in PWM mode.

As shown in FIG. 2, in PWM mode, the brightness of a screen is determined by the amplitude of a current provided by the data driver and the pulse width.

That is, to exhibit a desired brightness in every scan line, discharging and charging take place for the adjustment of the pulse width.

Although the amount of charge supplied is great, the discharge current is not sufficient enough to drive the pixels of the display panel for illumination. Therefore, power consumption in PWM mode was extremely high.

FIG. 3 illustrates an output waveform of a data driver when the organic EL display panel of FIG. 1 is in PAM mode.

As shown in FIG. 3, the brightness of a screen in PAM mode is inversely proportional to the amplitude of the driving current provided by the data driver.

Similar to the PWM mode, the data driver output is discharged and charged per scan line.

Even though the discharge current in the PAM mode is relatively less than that of the PWM mode, it is still not sufficient to drive the display panel for illumination. Therefore, the power consumption problem has remained unsolved.

There have been many attempts to solve the above problem by not discharging the accumulated charge at the data driver output in the PAM mode for example. However in such case, the brightness of a next scan line was varied according to the amount of accumulated charge at the data driver output of the previous scan line, which in turn created deviated image brightness and deteriorated the picture quality.

### SUMMARY OF THE INVENTION

Accordingly, the present invention is directed to an apparatus and method for operating a flat panel display that substantially obviates one or more problems due to limitations and disadvantages of the related art.

An object of the present invention is to provide an apparatus and method for operating a flat panel display featuring low-power consumption and superior picture quality, by minimizing the discharge current that has no effective contribution towards the operation of the flat panel display (i.e., an organic EL display) and the generation of light thereby and reducing brightness deviation between lines.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for operating a flat panel display with a plurality of data lines and scan lines, in which the apparatus includes: a current reference generator for generating a data drive current reference for providing a drive current proportional to the size of an input data from outside, and a charge/discharge current reference according to a difference of the data size between the scan lines; and a data driver output for providing directly to the display panel a current corresponding to each of the current references.

In the exemplary embodiment, the current reference generator compares among the scan lines a previous line data with a next line data to be driven, and generates the charge/discharge current reference according to the difference between the drive currents.

In the exemplary embodiment, if the drive current of the previous line is higher than the drive current of the next line to be driven, the charge reference for balancing the difference current is generated. Also, if the drive current of the previous line is lower than the drive current of the next line to be driven, the discharge reference for balancing the difference current is generated.

Preferably, the apparatus further includes: an analog Mux for muxing the drive current reference generated from the current reference generator, and the charge/discharge current reference being inputted.

Preferably, the apparatus further includes: a timing generator for providing a timing for current supply according to each of the current references.

In the exemplary embodiment, the current reference generator includes: a first memory for saving an N-th scan line data; a second memory for saving a previously inputted (N−1)-th line scan data; a subtracter for obtaining a difference between the N-th and the (N−1)-th scan line data; a first D/A converter (Digital-Analog Converter) for converting the N-th scan line data to an analog data and thereby, generating the drive current reference; and a second D/A converter for receiving the result of the subtraction outputted from the subtracter and thereby, generating the charge/discharge current reference according to the result.

Another aspect of the present invention provides a method for operating a flat panel display with a plurality of data lines and scan lines, the method including the steps of: generating a data drive current reference for providing a drive current proportional to the size of an input data from outside; generating a charge/discharge current reference according to a difference of the data size between the scan lines; and providing directly to the display panel a current corresponding to each of the current references.

In another aspect of the present invention, a method for operating a flat panel display with a plurality of data lines and scan lines includes the steps of: generating a charge/discharge current reference proportional to a difference of the data size between the scan lines; and adjusting a charge/discharge current supply timing according to the charge/discharge current reference, and outputting a corresponding current to the flat panel display.

In the exemplary embodiment, the charge/discharge current reference is generated by comparing among the scan lines a previous line data with a next line data to be driven, and generating the charge/discharge current reference according to the difference between the drive currents.

In the exemplary embodiment, the amplitude of the charge/discharge current is fixed at a determined level.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a related art organic EL display panel and operation module thereof;

FIG. 2 illustrates an output waveform of a data driver in PWM mode according to the related art;

FIG. 3 illustrates an output waveform of a data driver in PWM mode according to the related art;

FIG. 4 illustrates an organic EL display panel and operation module thereof according to the present invention;

FIG. 5 illustrates an internal structure of a current reference generator according to the present invention; and

FIG. 6 illustrates an output waveform of a data driver in PAM mode according to the present invention.

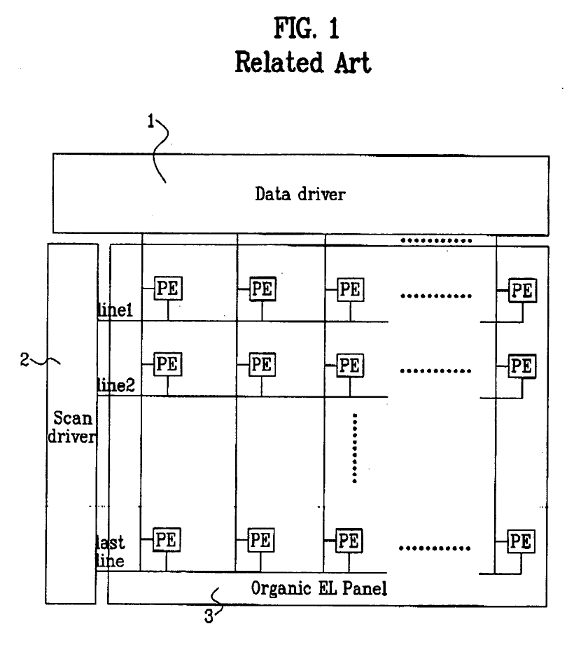

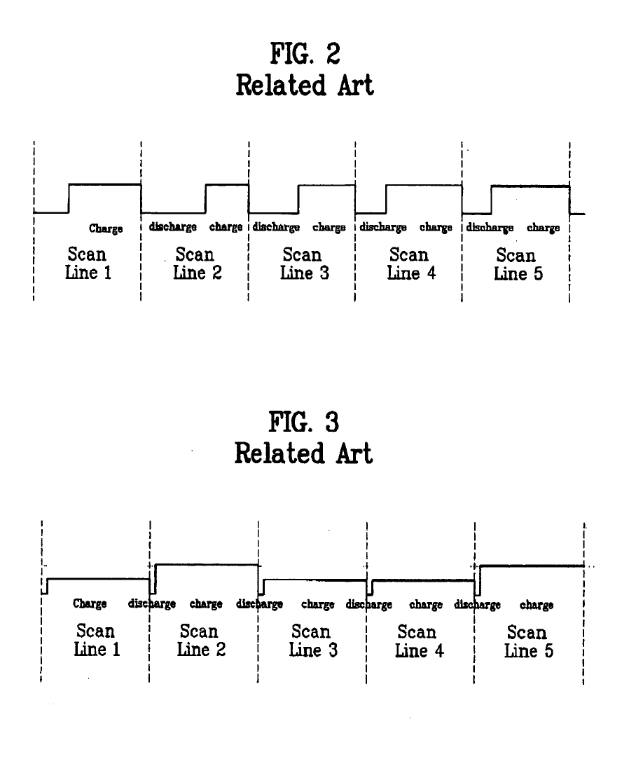

### DETAILED DESCRIPTION OF THE PREFERRED EMBODIMENTS

Reference will now be made in detail to the preferred embodiments of the present invention, examples of which are illustrated in the accompanying drawings.

The terminology used in the following description is general ones that are currently being used. There are also new terms introduced by the applicants of the present invention to describe a new technology in a best way. Those new terms will be explicitly explained in corresponding places. Therefore, it should be noted that the present invention is not to be understood simply by terminology itself but by the technical features and meanings associated with the terminology.

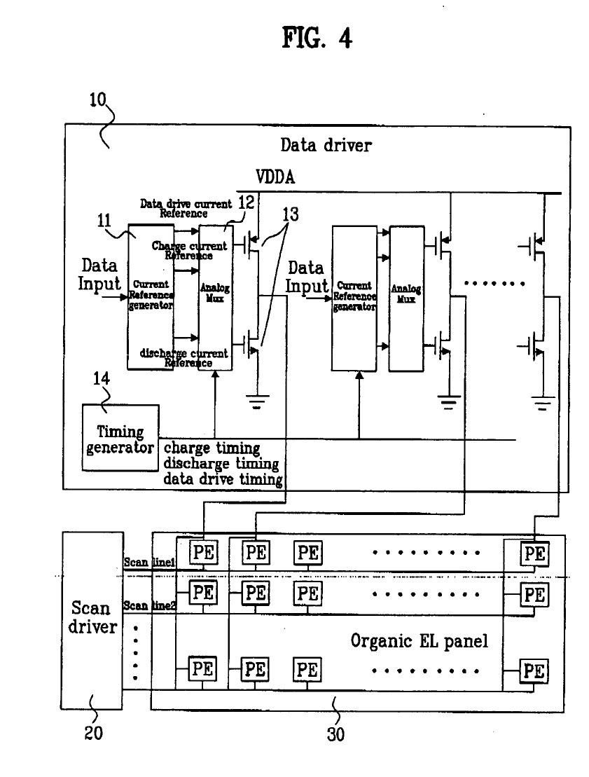

FIG. 4 illustrates an organic EL display panel and operation module thereof (more specifically, a data driver) according to the present invention.

As shown in FIG. 4, the data driver 10 for the organic EL display includes a current reference generator 11 for providing a drive current for use in a display panel 30 in PAM mode, an analog Mux 12 for switching a data drive current reference from the current reference generator 11 with a charge/discharge current reference being inputted, a data driver output 13 for providing the current directly to the organic EL panel 30 according to the reference value, and a timing generator 14 for controlling data drive timing, charge timing and discharge timing.

The above-described structure is designed in such a manner that the quantity of light emitted from the organic EL panel 30 is proportional to the amount of the current flowing in each pixel PE. Thus, the quality of light being generated can be controlled by controlling the amount of the current flowing in the pixels PE in the organic PE panel 30 in accordance with an input data in the current reference generator 11.

Here, the current reference generator 11 provides the drive current in PAM mode. Moreover, the current reference generator 11 not only generates a data drive current but also a charge/discharge current reference according to the data difference between a previous scan line data and a next scan line data, whereby the discharge current that has no effective contribution towards the emission of light can be reduced.

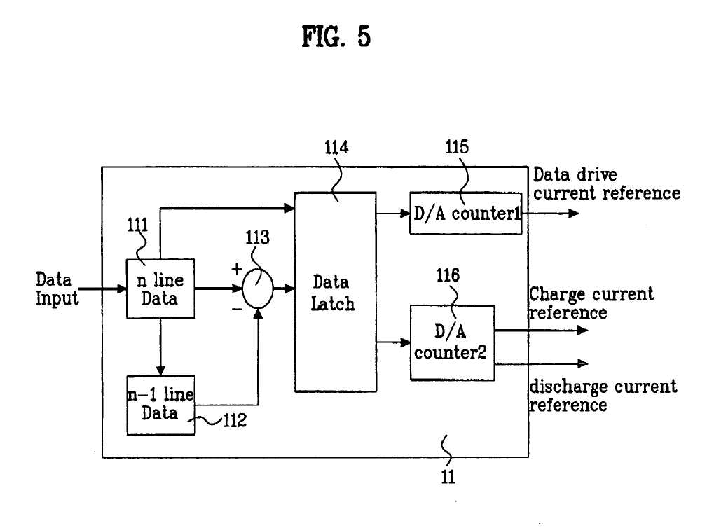

The following will now elaborate the operational procedure of the current reference generator 11 with reference to FIG. 5.

FIG. 5 is a block diagram illustrating an internal structure of the current reference generator according to the present invention.

As shown in FIG. 5, the current reference generator 11 includes a memory 111 for saving an N-th scan line data, a memory 112 for saving an (N−1)-th scan line data, a subtracter 113 for obtaining a difference between the N-th and the (N−1)-th scan line data, a data latch 114 for saving the N-th scan line data and the result of the subtraction outputted from the subtracter 113, a D/A converter1 (Digital-Analog Converter) 115 for converting the N-th scan line data to an analog data and thereby generating a reference in need of the operation of the display panel, and a D/A converter2 116 for converting the result of the subtraction to an analog data and thereby generating a reference for charging or discharging according to the reference.

The operational relations between the elements in the current reference generator 11 will now be explained below.

An input data in the current reference generator 11 is saved in the N-th line data memory 111, and a previously inputted data is saved in the (N−1)-th line data memory 112.

The D/A converter1 115 generates a data drive current reference proportional to the N-th line data.

The subtracter 113 finds the difference between the N-th scan line data and the (N−1)-th line data. If the N-th scan line data is greater, the D/A converter2 116 generates a charge current reference (i.e., current or voltage) in proportion to the difference.

On the other hand, if the N-th scan line data is smaller the D/A converter2 116 generates a discharge current reference (i.e., current or voltage) in proportion to the difference.

Thusly generated data drive current reference, charge current reference or discharge current reference is inputted into the analog Mux 12 of FIG. 4.

The data drive current reference, charge current reference or discharge current reference, and a timing value for each of the reference current values generated from the timing generator 14 get muxed through the analog Mux 12 and are outputted to the data driver output 13.

A voltage enters the data driver output 13 via a VDDA line and an appropriate current for the current reference value is supplied directly to the organic EL panel. In this manner, the organic EL panel 30 is able to emit light.

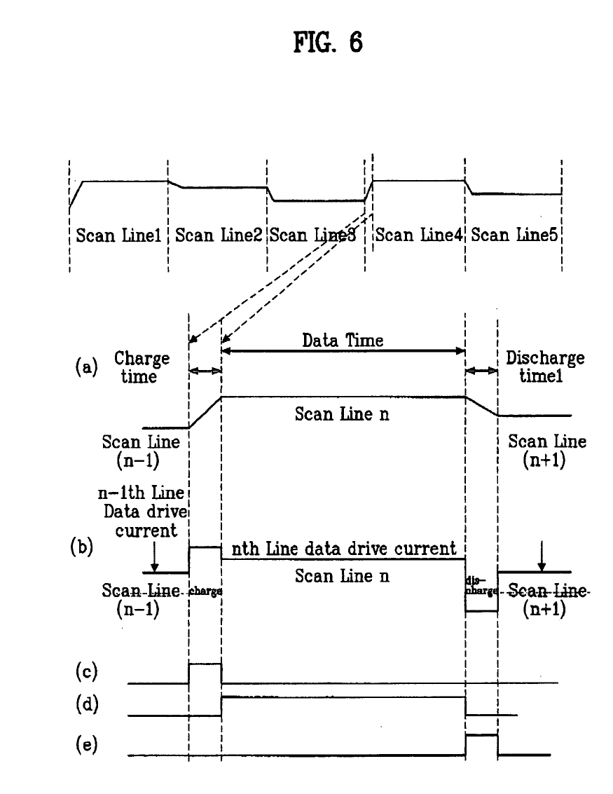

The output waveform of the data driver output 13 is illustrated in FIG. 6.

As illustrated in FIG. 6, light is not emitted by performing the discharging and charging, and the output waveform of the data driver output 13 is varied according to the difference between the present scan line and the previous scan line.

The output waveform of the data driver output 13 is explained in more detail as follows.

FIG. 6(a) illustrates part of the output waveform of the data driver output according to the present invention. Particularly, the drawing depicts a change in the voltage.

Referring to FIG. 6(a), the voltage change is proportional to the difference between the (N−1)-th scan line and the N-th scan line. This explains why the voltage waveform reflects a linear shape at the transition of line driving.

In PAM mode, the deviation between the lines for the same data rarely exists because the charging and discharging time are much shorter than the data drive time.

FIG. 6(b) illustrates part of the output waveform of the data driver output according to the present invention. Particularly, the drawing depicts a change in the current.

As illustrated in FIG. 6(b), the drive current in the N-th scan line is higher than the drive current in the (N−1)-th scan line. Thus, a current for balancing the difference should be charged.

Similarly, since the drive current in the (N+1)-th scan line is lower than the drive current in the N-th scan line, a current for balancing the difference should be discharged.

At this time, the charge or discharge current is slightly higher than the change of the amplitude of the data drive current in order to reduce the charging or discharging period of time.

FIG. 6(c) to FIG. 6(e) illustrate, respectively, the timing of the current generation corresponding to part of the output waveform of the data driver output according to the present invention.

More specifically, in FIG. 6(c), the drive current in the N-th scan line is higher than the drive current in the (N−1)-th scan line, so a current for balancing the difference is charged at the timing given in FIG. 6(c).

FIG. 6(d) illustrates a data drive timing for generating a drive current for the data that corresponds to the N-th scan line.

Lastly, FIG. 6(c) illustrates a discharge timing. As is seen in the drawing, the drive current in the (N−1)-th scan line is lower than the drive current in the N-th scan line, so a current for balancing the difference is discharged at the timing given in FIG. 6(e).

Comparing the output waveform of the data driver output in FIG. 6 with that of the related art in FIG. 3, it is evident that the amount of the discharge current that has no effective contribution towards the emission of light is much reduced.

Besides the above-described method, the amplitude of the charge and the discharge current can be fixed, and the optimal charge and discharge time proportional to the data difference between the scan lines can be obtained by properly controlling the timing(s) of the timing generator, thereby regulating the amount of the charge and discharge current.

Meanwhile, the present invention can also be applied to other flat panel displays in PAM mode, including LCDs, FEDs, and PDPs.

In conclusion, the apparatus and method for operating the organic EL display panel according to the present invention has the following advantages.

Firstly, by regulating the amount of the charge and discharge current for data drive according to the size of the input data, the amount of the discharge current that has no effective contribution towards the emission of light was much reduced, which in turn reduced the total power consumption.

Secondly, by reducing the brightness deviation between lines, the organic EL display panel can be operated with low power consumption without deteriorations in the picture quality.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. An apparatus for operating a flat panel display with a plurality of data lines and scan lines, the apparatus comprising:
a current reference generator for generating a data drive current reference for providing a drive current proportional to the size of an input data from outside, and a charge/discharge current reference according to a difference of the data size between the scan lines; and
a data driver output for providing directly to the display panel a current corresponding to each of the current references.

2. The apparatus according to claim 1, wherein the current reference generator compares among the scan lines a previous line data with a next line data to be driven, and generates the charge/discharge current reference according to the difference between the drive currents.

3. The apparatus according to claim 2, wherein if the drive current of the previous line is higher than the drive current of the next line to be driven, the charge reference for balancing the difference current is generated.

4. The apparatus according to claim 2, wherein if the drive current of the previous line is lower than the drive current of the next line to be driven, the discharge reference for balancing the difference current is generated.

5. The apparatus according to claim 1, further comprising:
an analog Mux for muxing the drive current reference generated from the current reference generator, and the charge/discharge current reference being inputted.

6. The apparatus according to claim 1, further comprising:
a timing generator for providing a timing for current supply according to each of the current references.

7. The apparatus according to claim 1, wherein the current reference generator comprises:
a first memory for saving an N-th scan line data;
a second memory for saving a previously inputted (N−1)-th line scan data;
a subtracter for obtaining a difference between the N-th and the (N−1)-th scan line data;
a first D/A converter (Digital-Analog Converter) for converting the N-th scan line data to an analog data and thereby, generating the drive current reference; and
a second D/A converter for receiving the result of the subtraction outputted from the subtracter and thereby, generating the charge/discharge current reference according to the result.

8. A method for operating a flat panel display with a plurality of data lines and scan lines, the method comprising the steps of:
generating a data drive current reference for providing a drive current proportional to the size of an input data from outside;
generating a charge/discharge current reference according to a difference of the data size between the scan lines; and
providing directly to the display panel a current corresponding to each of the current references.

9. The method according to claim 8, wherein the charge/discharge current reference is generated by comparing among the scan lines a previous line data with a next line data to be driven, and generating the charge/discharge current reference according to the difference between the drive currents.

10. The method according to claim 9, wherein if the drive current of the previous line is higher than the drive current of the next line to be driven, the charge reference for balancing the difference current is generated.

11. The method according to claim 9, wherein if the drive current of the previous line is lower than the drive current of the next line to be driven, the discharge reference for balancing the difference current is generated.

12. The method according to claim 8, further comprising the step of:
providing a timing for current supply according to each of the current references.

13. The method according to claim 12, further comprising:
switching (or muxing) one of the drive current, the charge current and the discharge current according to the timing given, and outputting a corresponding current.

14. The method according to claim 8, wherein the charge/discharge current reference generating step comprises the sub-steps of:
saving the N-th scan line data and the (N−1)-th line scan data, respectively;
obtaining a difference between the N-th and the (N−1)-th scan line data;
converting a current or voltage proportional to the difference into an analog data; and generating the charge or discharge current reference.

15. A method for operating a flat panel display with a plurality of data lines and scan lines, the method comprising the steps of:
generating a charge/discharge current reference proportional to a difference of the data size between the scan lines; and
adjusting a charge/discharge current supply timing according to the charge/discharge current reference, and outputting a corresponding current to the flat panel display.

16. The method according to claim 15, wherein the charge/discharge current reference is generated by comparing among the scan lines a previous line data with a next line data to be driven, and generating the charge/discharge current reference according to the difference between the drive currents.

17. The method according to claim 15, wherein the amplitude of the charge/discharge current is fixed at a predetermined level.
